(19) United States
(12) Patent Application Publication
(10) Pub. No.: US 2012/0141703 A1
(43) Pub. Date: Jun. 7, 2012

(54) AIRCRAFT OR SPACECRAFT CASING

(75) Inventor: Matthias Goetze, Dresden (DE)

(73) Assignee: IMA MATERIALFORSCHUNG UND ANWENDUNGSTECHNIK GMBH, Dresden (DE)

(21) Appl. No.: 13/380,066

(22) PCT Filed: Dec. 30, 2010
(86) PCT No.: PCT/EP2010/070934

§ 371 Date: Feb. 22, 2012

(30) Foreign Application Priority Data
Dec. 30, 2009 (DE) 10 2009 060 876.1

(51) Int. Cl. B32B 1/08

(52) U.S. Cl. 428/34.1

(57) ABSTRACT

An aircraft or spacecraft casing includes a composite shell made of first rod elements or sandwich core elements, and first skin elements connected to the first rod elements or sandwich core elements such that all exterior loads are received jointly thereby. The shell has an opening receiving a rod supporting structure of at least two groups of second rod elements. Second rod elements of a first group are arranged parallel to each other, and second rod elements of different groups are arranged non-parallel to each other. The second rod elements are connected to the composite shell at the edge of the opening and a second skin element is arranged in each partial opening delimited by second rod elements such that free edges of the second skin element are free of bending moments and tangential forces, and exterior loads are redirected solely from the second rod elements into the composite shell.

The invention relates to an aircraft or spacecraft casing according to the preamble of claim 1.

The invention involves specific solution approaches for supporting, mechanical structures, for example of an aircraft fuselage, particularly one loaded by internal overpressure. The primary objective is the substitution of the known window and door areas. Application is unlimited in terms of material selection.

The invention can simultaneously be extended to any plane supporting structures, for example with less complicated loading scenarios, in which a cutout disrupting the flow of force is considered to be necessary.

The documents listed below form the prior art in this field:
/1/ Pettit, R. G./ Wang, J. J./ Toh, C.; “Validated Feasibility Study of integrally stiffened metallic Fuselage Panels for Reducing Manufacturing Costs”—Report CR-2000-209342; Boeing/ NASA May 2000
/2/ Hansen, L. U./ Häusler, S. M./ Horst, P.; “Potential Benefits of integrally stiffened Aircraft Structures”—Presentation; 1^{st} CEAS Berlin 10-14 Sep. 2007
/3/ The Boeing Company; “Apparatus and Methods for Reinforcing a structural Panel”—EP1642826A1; Priority 4 Oct. 2004 (U.S. Pat. No. 958,079)
/4/ The Boeing Company; “Apparatus and Methods for Installing Aircraft Window Panel”—EP1642824A2; Priority 4 Oct. 2004 (U.S. Pat. No. 958,080)
/5/ McDonnell Douglas Corp.; “Composite Shell formed as a Body of Rotation and Method and Mandrel for Making same”—U.S. Pat. No. 5,814,386A; Priority 29 Sep. 1998 (RU95120432 1 Dec. 1995)
/6/ McDonnell Douglas Corp.; “Composite Shell shaped as a Body of Revolution and Panel Connection Joint”—U.S. Pat. No. 6,068,902; Priority 30 May 2000 (RU96121193 29 Oct. 1996)
/7/ McDonnell Douglas Corp.; “Composite Shell shaped as a Body of Revolution”—U.S. Pat. No. 6,155,450; Priority 5 Dec. 2000 (RU96121435 29 Oct. 1996)

Windows, doors, gateways, etc. are generally treated as interruptions in an orthogonal or at least practically orthogonal mechanical structure. In this regard, ‘orthogonal’ is often translatable into ‘orthotropic shells’ in the case of differential construction.

These shells are characterized by a supporting quasi-isotropic skin with reinforcing elements applied orthogonally, called stringers in the longitudinal direction and formers in the peripheral direction. The openings correspond to curved slots or rectangles with rounded corners. In terms of mechanical structure, an analogy with frames with rigid corners can be made. In particular in door cutouts, the doubler layers used according to the prior art in combination with formers and auxiliary formers illustrate this. The understanding upon which this notion is based leads to the dogma “keep cutouts as small as possible!”.

In the meantime, there is a noticeable tendency in research and development to design the surroundings in a manner which reflects the flow of force, see NASA /1/ and TU Braunschweig /2/. However, the understanding upon which this is based is not investigated in this instance.

Even in the case of first developments using fiber composite materials which, as has been heavily cited, imply customized use and structural rethinking, there is no paradigm shift. Boeing merely presents an approach to increasing the usable window area and simultaneously simplifying manufacture with fiber composite technology in the form of frame design:

All known attempts to develop the shape or surrounding mechanical structure are limited to the idea that a window in the aircraft fuselage cylinder constitutes a disruptive hole which should be kept small. This mindset is obvious in particular in the case of fuselages exposed to overpressure for flying altitudes above 3000 m. When looking at practical examples, the way in which these cutouts are dealt with is generally based on frames with rigid corners.

This is blatantly inconsistent with one of the contrary objectives for plans and designs of cabin interiors. In the case of the Boeing 787 model (DreamLiner), the dimensions of the window area do not change, although it is freely advertised as having windows which are 20% . . . 30% taller.

The attempts to integrate the window into the supporting structure of the fuselage can be understood as a continuation /3, 4/. The question of which transparent material could be suitable for withstanding the stresses has previously remained open. Now, the non-transparent frame included in the window assembly is presented as a solution approach.

The invention is intended to overcome the above-described significant limitation to aircraft design.

It aims to use in particular the area of the window of an aircraft as a fully valid component of the supporting structure/the airframe. It opens up the possibility of integrating windows, etc. according to design wishes.

The primary idea of the invention consists in the change to be implemented to the topology of the supporting structure from a plane supporting structure to a rod supporting structure and back again. The construction of the supporting structure is irrelevant. The openings formed in the rod supporting structure are closed by non-supporting yet pressure-tight elements.

These may be windows, and therefore also transparent, but also gateways or doors. In any case the invention provides an adaptation, that is to say a transition, between the individual areas of the entire supporting structure.

Without having to invest heavily in the bracing of light-weight structures, the object of improving known aircraft or spacecraft casings starting from the prior art to such an extent that openings in plane supporting structures can be formed more freely can be achieved with the invention described hereinafter in greater detail.

To achieve the above-described object, an aircraft or spacecraft casing is proposed which comprises a composite shell formed of first rod elements or sandwich core elements and first skin elements, which are connected to the first rod elements or sandwich core elements such that all exterior loads are received jointly by the first rod elements or sandwich core elements and the first skin elements, wherein the composite shell has at least one opening for a window, a door or the like, and wherein a rod supporting structure made of at least two groups of second rod elements is arranged in the opening in the composite shell, wherein second rod elements belonging to the same group are arranged parallel to each other, and second rod elements belonging to different groups are arranged non-parallel to each other, the second rod elements are connected to the composite shell at the edge of the opening and a second skin element is arranged in each partial opening delimited by second rod elements such that the free edges of the second skin element are free of bending moments and tangential forces, so that all exterior loads are redirected solely from the second rod elements into the composite shell.

The following advantages are provided by the described solution:

Elimination of rigid corners in plane supporting structures, practically unlimited increase in the extent of areas where openings are made, new, highly welcome design options for aircraft windows, alternative door and gateway cutouts as well as the possibility of the technological preparation of reinforced plane supporting structures which are not orthogonal.

In one embodiment the rod supporting structure is an autonomous rod supporting structure which is inserted into the opening in the composite shell by connecting the second rod elements of the rod supporting structure to the composite shell, in particular the first rod elements and/or skin elements. In this context, an autonomous rod supporting structure is a closed assembly which, in contrast to solutions in which the second rod elements of the rod supporting structure are designed so as to be completely or partly integral with the first rod elements of the composite shell, can be prefabricated separately and only inserted into the opening in the composite shell and connected thereto in the assembled state.

Alternatively or additionally, at least two second rod elements of the rod supporting structure may be interconnected by node elements. Such node elements, which are known per se, connect the second rod elements to form a rod supporting structure, wherein a high level of overall strength can be achieved.

In a development, the rod supporting structure comprises star-shaped segments which each comprise at least three second rod elements, interconnected on one side, and are interconnected by connection of free ends of the second rod elements. In other words, a star-shaped segment is an element in which at least three second rod elements are each interconnected via one end at a common, central point and the second rod elements extend outwardly from this central point. The rays, thus formed, of the star-shaped segment have at their outermost points free ends which can be connected to the free ends of other star-shaped segments, thus forming an autonomous rod supporting structure.

In one embodiment the rod supporting structure comprises polygonal segments which each comprise at least three interconnected second rod elements and are interconnected by connection of their corners. For example, the autonomous rod supporting structure may be composed of a plurality of triangular or polygonal segments which, at their corners, are each connected to the corner of an adjacent triangular or polygonal segment. The inside of each of these polygonal segments forms an opening in which a second skin element may be arranged. The outer faces of a plurality of polygonal segments also together form such an opening, in which a second skin element can be arranged.

In accordance with another embodiment of the invention, the rod supporting structure may also comprise polygonal segments which each comprise at least three interconnected second rod elements and are interconnected by connection of their sides. For example, the autonomous rod supporting structure may be composed of a plurality of triangular or polygonal segments, which each are connected on the outer face of a second rod element to the outer face of an adjacent second rod element of another triangular or polygonal segment. The inside of each of these polygonal segments forms an opening in which a second skin element can be arranged.

In another embodiment of the invention the rod supporting structure is composed of continuous second rod elements which each extend, uninterrupted, between two edges of the opening and are interconnected at intersecting points. For this purpose, second rod elements of a first group may comprise clearances, through which second rod elements of a second group extend. By means of suitable connection means, such as sheet metal brackets or the like, the second rod elements of the first and second groups are interconnected at the intersecting points so as to increase strength.

In any of the above-described embodiments, at least three second rod elements may form an open node which is a compact structure which is used as a reinforcing element and/or is replaced by a reinforcing element. In other words, the second rod elements are arranged relative to one another in such a way that they do not cross at a common point, but are arranged slightly offset so that a polygonal node is formed. An autonomous rod supporting structure is thus formed, comprising two types of openings: smaller openings, which can be closed be relatively small second skin elements, for example reinforcing elements (“open nodes”), and larger openings, which can be closed by relatively large second skin elements, for example windows.

As described above, this type of autonomous rod supporting structure may be formed, for example, by polygonal segments which each comprise at least three interconnected second rod elements and are interconnected by connection of their corners or by connection of their sides, or by continuous second rod elements which each extend, uninterrupted, between two edges of the opening and are interconnected at intersecting points.

The openings in the autonomous rod supporting structure and/or the second skin elements and/or reinforcing elements attached therein may also have rounded corners and/or may be oval, for example elliptical, and/or circular.

Furthermore, the first rod elements of the composite shell may form an orthogrid or an isogrid. Similarly, the second rod elements of the rod supporting structure may be arranged relative to one another in such a way that they form an orthogrid or an isogrid.

Specific advantages in terms of the design possibilities for window or door cutouts are provided if the opening in the composite shell and the rod supporting structure arranged therein have an outer contour which is not rectangular, but polygonal.

The invention will be explained in greater detail hereinafter on the basis of exemplary embodiments and associated drawings, in which:

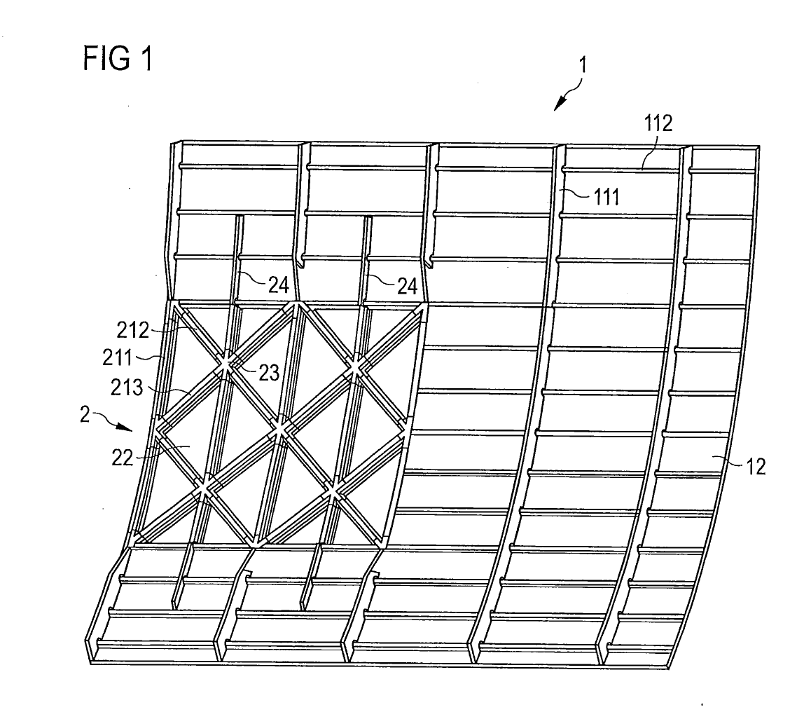

FIG. 1 shows a first exemplary embodiment;

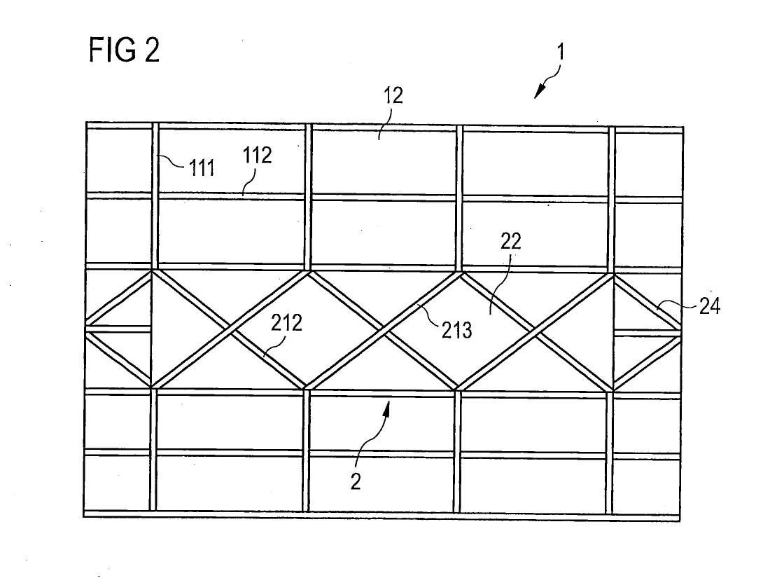

FIG. 2 shows a second exemplary embodiment and

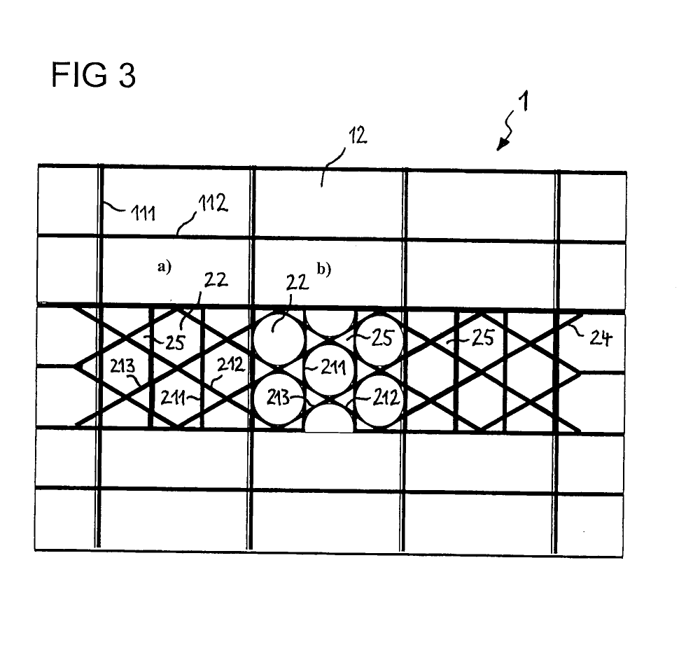

FIG. 3 shows a third exemplary embodiment of the aircraft or spacecraft casing according to the invention.

FIG. 1 is a perspective view of a detail of a composite shell 1. The composite shell 1 consists of two groups of first rod elements 111, 112 and first skin elements 12 connected to said first rod elements 111, 112. The first rod elements 112 extending in the longitudinal direction of the later aircraft fuselage are also referred to as stringers; the first rod elements 111 extending transverse thereto and peripherally are also referred to as formers.

A rod supporting structure 2 is arranged in a rectangular opening in the composite shell 1 and consists of three groups of second rod elements 211, 212, 213. The second rod elements 211 of a first group extend transverse to the longitudinal direction of the later aircraft fuselage, similarly to the formers 111 of the composite shell. However, they are arranged at only half the distance from one another as the first rod elements.

Those second rod elements 211 of the first group which contact a first rod element 111 (former) of the composite shell 1 at the edge of the rod supporting structure 2 are rigidly connected to said first rod elements by fitting elements 24. The second rod elements 211 of the first group arranged therebetween contact first skin elements 12 of the composite shell 1 at the edge of the rod supporting structure 2 and are connected to said first skin elements by fitting elements 24. The fitting elements 24 may accordingly be designed differently, depending on whether they produce the transition from a rod element of the rod supporting structure 2 to a rod element or a skin element or another structural element of the composite shell 1.

By contrast, the second rod elements 212 of a second group and the second rod elements 213 of a third group extend diagonally, that is to say they follow a helical line around the later aircraft fuselage. The second rod elements 212 of the second group and the second rod elements 213 of the third group extend perpendicular to one another, however, so that they cross one another, more specifically precisely at the second rod elements 211 of the first group.

Second rod elements 211, 212, 213 of each of the three groups are thus involved at each intersecting point within the rod supporting structure 2. The second rod elements 211, 212, 213 are interconnected by node elements 23 at these intersecting points.

The second rod elements 212, 213 of the second and third groups are arranged at such a distance from one another that, at the lateral edge of the rod supporting structure 2, they meet every third one of the first rod elements 112 extending in the longitudinal direction of the composite shell 1 (stringers) and are connected thereto.

Owing to the relative arrangement of the three groups of second rod elements 211, 212, 213, the rod supporting structure 2 is divided into triangular fields which are closed by second skin elements 22. In the exemplary embodiment, the second skin elements 22 are attached to the inner face of the rod supporting structure 2, whilst the first skin elements 12 of the composite shell 1 are attached to the outer face of the composite shell 1. The second skin elements 22 are mounted in such a way that they are free of bending moments and tangential forces at their edges.

FIG. 2 is a simple plan view of a detail of a composite shell 1. The composite shell 1 consists of two groups of first rod elements 111, 112 and first skin elements 12 connected to said first rod elements 111, 112.

A rod supporting structure 2 is arranged in a rectangular opening in the composite shell 1 and consists of two groups of second rod elements 212, 213.

The second rod elements 212 of a first group and the second rod elements 213 of a second group extend diagonally, that is to say they follow a helical line around the later aircraft fuselage. The second rod elements 212 of the first group and the second rod elements 213 of the second group extend perpendicular to one another, however, so that they cross one another.

The second rod elements 212, 213 of the first and second groups are arranged at such a distance from one another that, at the lateral edge of the rod supporting structure 2, they meet each of the rod elements 111 extending transverse to the longitudinal direction of the composite shell 1 (formers), but only every second one of the first rod elements 112 extending in the longitudinal direction of the composite shell 1 (stringers) and are connected thereto by means of fitting elements 24.

Owing to the relative arrangement of the two groups of second rod elements 212, 213, the rod supporting structure 2 is divided into quadrangular and triangular fields which are each closed by second skin elements 22. In the exemplary embodiment, the second skin elements 22 are attached to the inner face of the rod supporting structure 2, whilst the first skin elements 12 of the composite shell 1 are attached to the outer face of the composite shell 1. The second skin elements 22 are mounted in such a way that they are free of bending moments and tangential forces at their edges.

FIG. 3 is a simple plan view of a detail of a composite shell 1. The composite shell 1 consists of two groups of first rod elements 111, 112 and first skin elements 12 connected to said first rod elements 111, 112.

A rod supporting structure 2 is arranged in a rectangular opening in the composite shell 1 and consists of three groups of second rod elements 211, 212, 213. The second rod elements 211 of a first group extend transverse to the longitudinal direction of the later aircraft fuselage, similarly to the formers 111 of the composite shell. However, they are arranged relative to one another at only a third of the distance between the first rod elements 111.

By contrast, the second rod elements 212 of a second group and the second rod elements 213 of a third group extend diagonally, that is to say they follow a helical line around the later aircraft fuselage. The second rod elements 212 of the second group and the second rod elements 213 of the third group extend relative to one another and relative to the second rod elements 211 of the first group so that they do not cross one another at a common point, but form an open node.

The small openings formed in each such open node are closed by reinforcing elements 25, which are triangular in the exemplary embodiment. Second rod elements 211, 212, 213 of each of the three groups are thus involved in each open node within the rod supporting structure 2.

The large openings formed between the open nodes are closed by second skin elements 22, which are windows in the exemplary embodiment and are hexagonal in variant (a), but circular in variant (b).

The second rod elements 212, 213 of the second and third groups are arranged at such a distance from one another that, at the lateral edge of the rod supporting structure 2, they meet each of the first rod elements 112 extending in the longitudinal direction of the composite shell 1 (stringers) and are connected thereto.

Owing to the relative arrangement of the three groups of second rod elements 211, 212, 213, the rod supporting structure 2 is divided into triangular and hexagonal or circular fields which are closed by reinforcing elements 25 or second skin elements 22. In the exemplary embodiment, the second skin elements 22 are attached to the inner face of the rod supporting structure 2, whilst the first skin elements 12 of the composite shell 1 are attached to the outer face of the composite shell 1. The second skin elements 22 are mounted in such a way that they are free of bending moments and tangential forces at their edges.

### LIST OF REFERENCE NUMERALS

1 composite shell
111 first rod elements (formers)
112 first rod elements (stringers)
12 first skin elements
2 rod supporting structure
211 second rod elements (peripheral)
212 second rod elements (diagonal)
213 second rod elements (diagonal)
22 second skin elements
23 node elements
24 fitting elements
25 open node, reinforcing element

1. An aircraft or spacecraft casing comprising a composite shell formed of first rod elements or sandwich core elements, and first skin elements connected to the first rod elements or sandwich core elements such that all exterior loads are received jointly by the first rod elements or sandwich core elements and the first skin elements, wherein the composite shell has at least one opening for a window, a door or the like, and further including a rod supporting structure comprising at least two groups of second rod elements arranged in the at least one opening in the composite shell, wherein second rod elements belonging to a same group are arranged parallel to each other, and second rod elements belonging to different groups are arranged non-parallel to each other, the second rod elements are connected to the composite shell at an edge of the at least one opening and a second skin element is arranged in each partial opening delimited by second rod elements such that free edges of the second skin element are free of bending moments and tangential forces, so that all exterior loads are redirected solely from the second rod elements into the composite shell.

2. The aircraft or spacecraft casing as claimed in claim 1, wherein the rod supporting structure is an autonomous rod supporting structure inserted into the at least one opening in the composite shell by connecting the second rod elements of the rod supporting structure to the first rod elements and/or first skin elements.

3. The aircraft or spacecraft casing as claimed in claim 1, wherein at least two second rod elements of the rod supporting structure are interconnected by node elements.

4. The aircraft or spacecraft casing as claimed in claim 1, wherein the rod supporting structure comprises star-shaped segments which each comprise at least three second rod elements, interconnected on one side, and are interconnected by connection of free ends of the second rod elements.

5. The aircraft or spacecraft casing as claimed in claim 1, wherein the rod supporting structure comprises polygonal segments which each comprise at least three interconnected second rod elements and are interconnected by connection of their corners.

6. The aircraft or spacecraft casing as claimed in claim 1, wherein the rod supporting structure comprises polygonal segments which each comprise at least three interconnected second rod elements and are interconnected by connection of their sides.

7. The aircraft or spacecraft casing as claimed in claim 1, wherein the rod supporting structure is composed of continuous second rod elements which each extend, uninterrupted, between two edges of the at least one opening in the composite shell and are interconnected at intersecting points.

8. The aircraft or spacecraft casing as claimed in claim 7, wherein at least one intersecting point comprises an open node in which at least three second rod elements are arranged relative to one another in such a way that a polygonal node defined by the second rod elements is formed.

9. The aircraft or spacecraft casing as claimed in claim 1, wherein at least one second skin element has rounded corners or is oval or circular.

10. The aircraft or spacecraft casing as claimed in claim 1, wherein the first rod elements form an orthogrid.

11. The aircraft or spacecraft casing as claimed in claim 1, wherein the first rod elements form an isogrid.

12. The aircraft or spacecraft casing as claimed in claim 1, wherein the second rod elements form an orthogrid.

13. The aircraft or spacecraft casing as claimed in claim 1, wherein the second rod elements form an isogrid.

14. The aircraft or spacecraft casing as claimed in claim 1, wherein the at least one opening in the composite shell and the rod supporting structure arranged therein have an outer contour which is not rectangular, but polygonal.
